(19) United States
(12) Patent Application Publication
(10) Pub. No.: US 2017/0075998 A1
(43) Pub. Date: Mar. 16, 2017

(54) ASSESSING TRANSLATION QUALITY

(71) Applicant: eBay Inc., San Jose, CA (US)

(72) Inventors: Jean-David Ruvini, Los Gatos, CA (US); Hassan Sawaf, Los Gatos, CA (US)

(21) Appl. No.: 14/853,233

(22) Filed: Sep. 14, 2015

(51) Int. Cl. G06F 17/30

(52) U.S. Cl. CPC G06F 17/30867; G06F 17/30401; G06F 17/3043

(57) ABSTRACT

According to various embodiments, the Translation Engine receives a current query in a first language from a target account. The Translation Engines determines a predicted product category for the current query from product categories of respective sets of historical queries from reference accounts. The Translation Engines determines a select translation of the current query in a second language based on the select translation triggering search results in the predicted product category.

### TECHNICAL FIELD

The present application relates generally to the technical field of computerized translations and, in one specific example, determining an accuracy of a translation of a search query.

### BACKGROUND

Typical electronic commerce (“e-commerce) sites provide users (e.g., sellers) with computer-implemented services for selling goods or services through, for example, a website. For example, a seller may submit information regarding a good or service to the e-commerce site through a web-based interface. Upon receiving the information regarding the good or service, the e-commerce site may store the information as a listing that offers the good or service for sale. Other users (e.g., buyers) may interface with the e-commerce site through a search interface to find goods or services to purchase. For example, some typical e-commerce sites may allow the user to submit a search query that includes, for example, search terms that may be matched by the e-commerce site against the listings created by the sellers. Listings that match the submitted search query may be presented to the buyer as a search result and the buy may then select one of the listing to effectuate a purchase. Similarities between various queries, keywords, etc. can be determined by implementing stemming technologies, semantic knowledge derived from synonym databases, by allowing limited dissimilarities according to edit distances, distributional semantics (i.e. Brown Clustering) and/or continuous semantics (i.e. distributed word vectors).

### BRIEF DESCRIPTION OF THE DRAWINGS

The present invention is illustrated by way of example, and not by way of limitation, in the figures of the accompanying drawings in which:

FIG. 1 is a network diagram depicting a publication system, according to one embodiment, having a client-server architecture configured for exchanging data over a network;

FIG. 2 is a block diagram illustrating components of a Translation Engine, according to some example embodiments.

FIG. 3 is a block diagram illustrating historical query data and historical browsing data accessible by a translation engine, according to some example embodiments;

FIG. 4 is a block diagram illustrating a query matching module determining a set of reference accounts with respective, historical queries that match respective, previous queries received from a target account, according to some example embodiments;

FIG. 5 is a block diagram illustrating a product category module determining respective product categories of respective, previous queries received from a target account, according to some example embodiments;

FIG. 6 is a block diagram illustrating a reference account filtering module determining reference accounts that have historical queries in the product categories of the respective, previous queries received from a target account, according to some example embodiments;

FIG. 7 is a block diagram illustrating a current query matching module determining a filtered account(s) with a historical query that matches a target account's current query, according to some example embodiments;

FIG. 8 is a block diagram illustrating a product category module determining a predicted product category of a target account's current query, according to some example embodiments;

FIG. 9 is a flow diagram illustrating an example of method operations involved in a method of translation a current query of a target account, according to some example embodiments;

FIG. 10 shows a diagrammatic representation of machine in the example form of a computer system within which a set of instructions may be executed causing the machine to perform any one or more of the methodologies discussed herein.

### DETAILED DESCRIPTION

Example methods and systems directed to a Translation Engine (hereinafter “TE”) are described. In the following description, for purposes of explanation, numerous specific details are set forth in order to provide a thorough understanding of example embodiments. It will be evident, however, to one skilled in the art that the present invention may be practiced without these specific details.

According to various embodiments, the Translation Engine receives a current query in a first language from a target account. The Translation Engine determines a predicted product category for the current query from product categories of respective sets of historical queries previously received from reference accounts. The Translation Engines determines a select translation of the current query in a second language based on the select translation triggering search results in the predicted product category.

In various embodiments, a Translation Engine has access to inventory listings in which products organized in the inventory listings are each associated with one or more predefined product categories, such as—for example—“Cell-Phone Accessories.” However, search queries are not associated with any predefined product categories because they are submitted by user accounts as general keywords or phrases. The Translation Engine determines the likely product category of any previous query by analyzing the browsing behavior of the corresponding account that submitted the query. For example, if a previously received query was the keyword “charger” and the corresponding account's browsing behavior—incidental to submitting the “charger” query—includes a selection to view a product listing for a cell-phone charger adapter and also includes a purchase for a cell-phone charger replacement chord, the Translation Engine determines the likely pre-defined product category of the “charger” query is “Cell-Phone Accessories.” If the Translation Engine accesses historical query data and historical browsing data that shows multiple accounts have previously submitted queries with keywords similar to “charger” and have corresponding browsing behaviors (e.g. clicking, viewing, saving, rating, purchases) with regard to products in the “Cell-Phone Accessories” product category, the Translation Engine determines with a high-degree of likelihood that a newly-received query similar to “charger” is most likely a request for search results that include products in the predefined product category of “Cell-Phone Accessories.”

In various embodiments, the Translation Engine receives a current query from a target account. The current query is in a foreign language. To provide correct search results for the current query, it must be translated into the working language of the Translation Engine in order to determine the proper search results that are to be sent back to the target account. However, situations occur where the Translation Engine determines that there are multiple, possible translations for the current query in the working language of the Translation Engine. In order to select the most relevant translation for the current query from the multiple, possible translations, the Translation Engine accesses historical query data and historical browsing data from reference accounts and identifies a set of reference accounts that have historical queries that match (are substantially similar to) previous queries received from the target account.

The Translation Engine determines the product categories of the target account's previous queries. The Translation Engine filters the set of reference accounts according to the target account's previous product categories to identify one or more filtered accounts. As such, a filtered account is an account with historical queries that match the target account's previous queries and the historical queries are further related to the product categories of the target account's previous queries. A filtered account, then, is very similar to the target account in terms of the queries used and the types of product categories searched. Since the target account and the filtered account(s) are similar, the filtered account's historical queries thereby provide the Translation Engine with context from which to predict the product category of the target account's current query.

The Translation Engine searches the historical queries of the filtered account(s) to identify a particular historical query that matches the current query of the target account. The Translation Engine determines the product category of the particular historical query and assigns it to the current query as a predicted product category. The Translation Engine determines a select translation, from the multiple possible translations for the current query, that returns search results for products in the predicted product category. The Translation Engine determines the select translation is the most accurate translation of the current query based on the select translation returning search results in the predicted product category.

### Platform Architecture

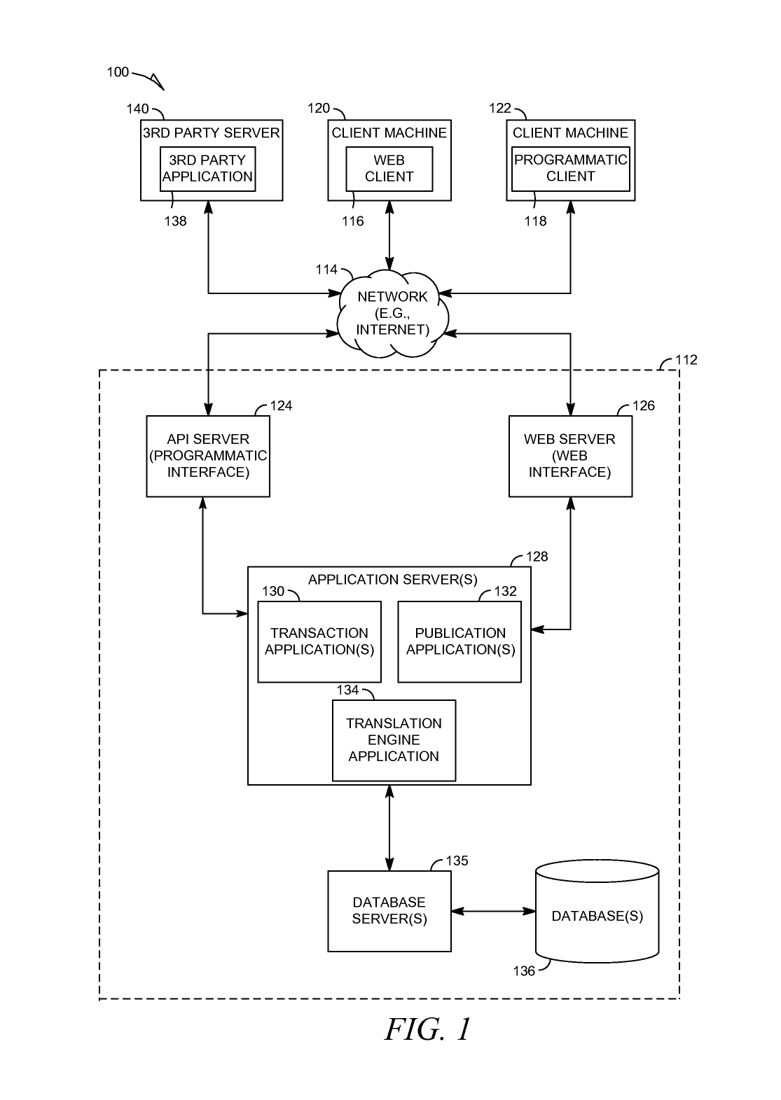

FIG. 1 is a network diagram depicting a translation system, according to one embodiment, having a client-server architecture configured for exchanging data over a network. The publication system 100 may be a transaction system where clients, through client machines 120, 122 and a third party server 140, may communicate, view, search, and exchange data with network based publisher 112. For example, the publication system 100 may include various applications for interfacing with client machines and client applications that may be used by users (e.g., buyers and sellers) of the system to publish items for sale in addition to facilitating the purchase and shipment of items and searching for items.

The network based publisher 112 may provide server-side functionality, via a network 114 (e.g., the Internet) to one or more clients. The one or more clients may include users that utilize the network based publisher 112 as a transaction intermediary to facilitate the exchange of data over the network 114 corresponding to user transactions. User transactions may include receiving and processing item and item related data and user data from a multitude of users, such as payment data, shipping data, item review data, feedback data, etc. A transaction intermediary such as the network based publisher 112 may include one or all of the functions associated with a shipping service broker, payment service and other functions associated with transactions between one or more parties. For simplicity, these functions are discussed as being an integral part of the network based publisher 112, however it is to be appreciated that these functions may be provided by publication systems remotely and/or decoupled from the network based publisher 112.

In various embodiments, the data exchanges within the publication system 100 may be dependent upon user selected functions available through one or more client/user interfaces (UIs). The UIs may be associated with a client machine, such as the client machine 120, utilizing a web client 116. The web client 116 may be in communication with the network based publisher 112 via a web server 126. The UIs may also be associated with a client machine 122 utilizing a client application 118, or a third party server 140 hosting a third party application 138. It can be appreciated in various embodiments the client machine 120, 122 may be associated with a buyer, a seller, payment service provider or shipping service provider, each in communication with the network based publisher 112 and optionally each other. The buyers and sellers may be any one of individuals, merchants, etc.

An application program interface (API) server 124 and a web server 126 provide programmatic and web interfaces to one or more application servers 128. The application servers 128 may host one or more other applications, such as transaction applications 130, publication applications 132 and a translation engine application 134. The application servers 128 may be coupled to one or more data servers that facilitate access to one or more storage devices, such as the data storage 136.

The transaction applications 130 may provide a number of payment processing modules to facilitate processing payment information associated with a buyer purchasing an item from a seller. The publication applications 132 may include various modules to provide a number of publication functions and services to users that access the network based publisher 112. For example, these services may include, inter alia, formatting and delivering search results to a client. The Translation Engine application 134, may include various modules to translate identify a relevant translation of a current search query received from a target account.

For example, the services of the Translation Engine application 134 further includes receiving a current query in a first language from a target account. Translation Engine application 134 determines a predicted product category for the current query from product categories of respective sets of historical queries from reference accounts. Translation Engine application 134 determines a select translation of the current query in a second language based on the select translation triggering search results in the predicted product category.

FIG. 1 also illustrates an example embodiment of a third party application 138, which may operate on a third party server 140 and have programmatic access to the network based publisher 112 via the programmatic interface provided by the API server 124. For example, the third party application 138 may utilize various types of data communicated with the network based publisher 112 and support one or more features or functions normally performed at the network based publisher 112. For example, the third party application 138 may receive a copy of all or a portion of the data storage 136 that includes buyer shipping data and act as the transaction intermediary between the buyer and seller with respect to functions such as shipping and payment functions. Additionally, in another embodiment, similar to the network based publisher 112, the third party application 138 may also include modules to perform operations pertaining to payment, shipping, etc. In yet another embodiment, the third party server 140 may collaborate with the network based publisher 112 to facilitate transactions between buyers and sellers, such as by sharing data and functionality pertaining to payment and shipping, etc.

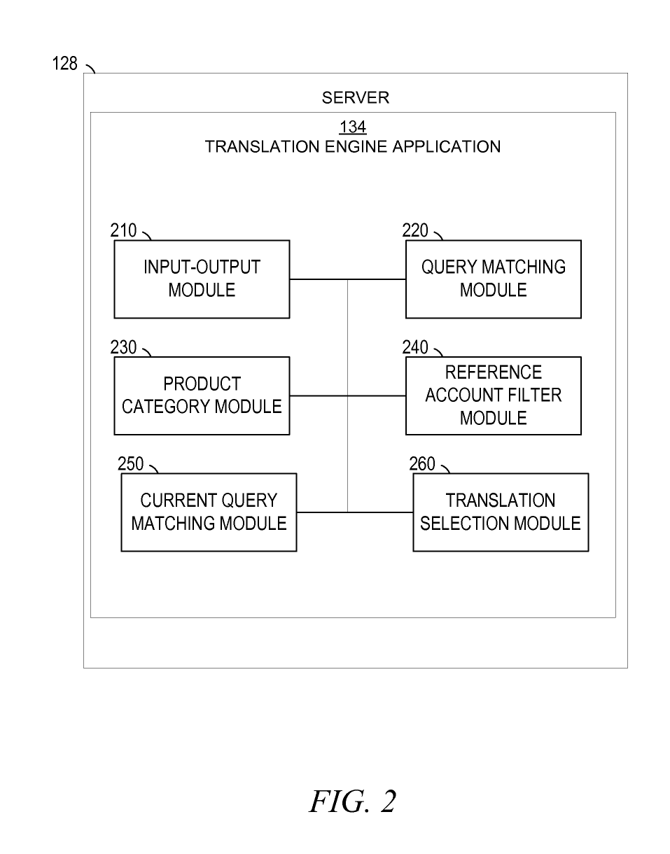

FIG. 2 is a block diagram illustrating components of a Translation Engine 134, according to some example embodiments. The components communicate with each other to perform the operations of the Translation Engine 134. The Translation Engine manager 134 is shown as including an input-output module 210, a query matching module 220, a product category module 230 and a reference account filter module 240, a current query matching module 250 and a translation selection module 260, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The input-output module 210 is a hardware-implemented module which manages, controls, stores, and accesses information regarding inputs and outputs. An input can be one or more search queries one language from a plurality of languages. An output can be a translation of the one or more search queries in a second language that is different than the language of the one or more received search queries.

The query matching module 220 is a hardware-implemented module which manages, controls, stores, and accesses information regarding matching previous queries with one or more historical queries. The query matching module 220 determines whether a portion of one or more previous search queries received from a target account meets a threshold of similarity with at least a portion of one or more historical queries received from respective reference accounts.

The product category module 230 is a hardware-implemented module which manages, controls, stores, and accesses information regarding identifying a product category for a search query. The product category module 230 accesses historical browsing data that represents browsing behavior that occurred incident to receipt of a respective query. Browsing behavior consists at least of the following activities: page views, link selections, item purchases, item ratings, user comments, bookmarking, etc. Each activity is related to a predefined product category. The product category module 230 determines the product category for the respective query based on the product categories that corresponds to the browsing behavior that occurred incident to receipt of a respective query.

The reference account filter module 240 is a hardware-implemented module which manages, controls, stores, and accesses information for filtering reference accounts that have historical queries that match previous queries of the target account. The reference account filter module 240 filters reference accounts according to the product categories of the target account's previous search queries. In some embodiments, a filtered account is a reference account with historical data that includes historical queries that match the target account's previous search queries and the matching historical queries also have the same product categories as the target account's previous search queries.

The current query matching module 250 is a hardware-implemented module which manages, controls, stores, and accesses information for matching a current query of a target account with one or more historical queries. The current query matching module 250 determines whether a portion of one or more current search queries received from a target account meets a threshold of similarity with at least a portion of one or more historical queries received from respective filtered accounts.

The translation selection module 260 is a hardware-implemented module which manages, controls, stores, and accesses information for translation a current query. The translation selection module 260 generates a plurality of possible translations for a current query of a target account. The translation selection module 260 retrieves search results for each of the plurality of possible translations. The translation selection module 260 selects a particular possible translation that returns search results in a predicted product category.

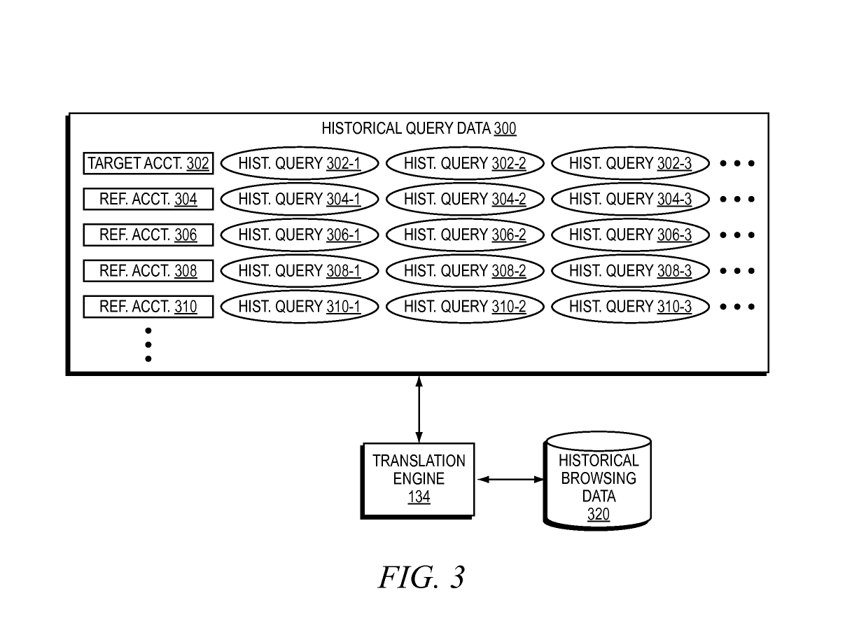

FIG. 3 is a block diagram illustrating historical query data 300 and historical browsing data 320 accessible by a translation engine 134, according to some example embodiments.

The publication system 100 includes historical query data 300 and historical browsing data 320 accessible by the translation engine 134. The historical query data 300 includes historical queries previously received from a plurality of accounts. The historical query data 300 includes historical queries 302-1, 302-2, 302-3 . . . from a target account 302, historical queries 304-1, 304-2, 304-3 . . . from a reference account 304, historical queries 306-1, 306-2, 306-3 . . . from a reference account 306, historical queries 308-1, 308-2, 308-3 . . . from a reference account 308, historical queries 310-1, 310-2, 310-3 . . . from a reference account 310.

The historical browsing data 320 includes browsing data incidental to each historical query in the historical query data 300. For example, with regard to historical query 304-2, the historical browsing data 320 includes page views, browsing behaviors (i.e. user clicks, user selections, browsing patterns, submitted user comments), purchases and ratings received from reference account 304 with respect to search results returned by the historical query 304-2.

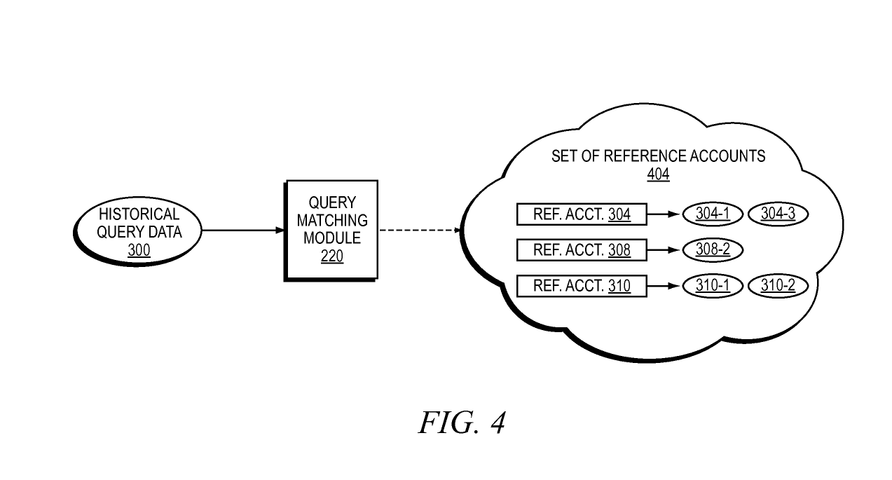

FIG. 4 is a block diagram illustrating a query matching module 220 determining a set of reference accounts 404 with respective, historical queries that match respective, previous queries received from a target account 302, according to some example embodiments.

The Translation Engine 134 applies a predefined time range (i.e. queries within the last week, month and/or year(s)) and/or predefined query amount (i.e. a specific number of queries) in order to identify recent historical queries 302-1, 302-2, 302-3 received from the target account 302 in the historical query data 300. Via, the query matching module 220, the Translation Engine 134 compares the historical queries of the reference accounts 304, 306, 308, 310 . . . to find historical queries that match with (are substantially similar to) the target account's 302 recent historical queries 302-1, 302-2, 302-3. In this example, the query matching module 220 identifies historical queries 304-1, 304-3, 308-2, 310-1 and 310-2 as historical queries from reference accounts 304, 308, 310, respectively, that are substantially similar to returns a set of reference accounts 404 that include the target account's 302 recent historical queries 302-1, 302-2, 302-3. In this example, the Translation Engine determines a set of reference accounts 404 as including reference accounts 304, 308, 310.

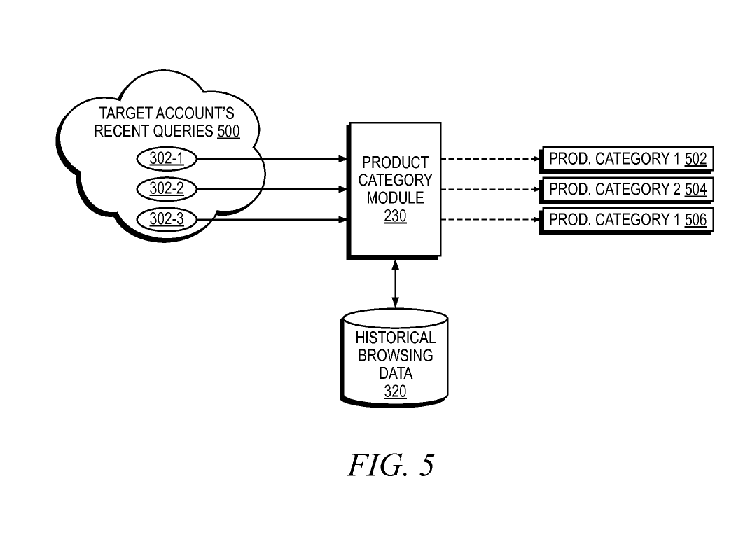

FIG. 5 is a block diagram illustrating a product category module 230 determining respective product categories of respective, previous queries received from a target account 302, according to some example embodiments.

Via the product category module 230, the Translation Engine 134 determines the respective product categories of the target account's 302 recent historical queries 302-1, 302-2, 302-3 based on the historical browsing data 320. For example, the Translation Engine 134 determines the likely product category of historical query 302-1 by analyzing the browsing behavior of the target account 302.

For example, if historical query 302-1 was the keyword “hoodie” and the target account's 302 browsing behavior—incidental to submitting the “hoodie” query—includes selections to view a product listing for a pull-over fleece jacket having a predefined product category of “Men's Outerwear” and a zip-up fleece jacket having a predefined product category of “Men's Sportswear” and also includes a purchase for a the pull-over fleece jacket, the Translation Engine determines the likely pre-defined product category of the “hoodie” query is “Men's Outerwear.” In this example, it is understood that the Translation Engine 134 selects “Men's Outerwear” as the likely pre-defined product category of the “hoodie” query instead of “Men's Sportswear” based on giving priority the purchase transaction.

In one example, the Translation Engine 134 similarly determines respective, likely product categories 502, 502, 506 for the target account's 302 recent historical queries 302-1, 302-2, 302-3. It is understood that historical queries 302-1 and 302-3 have the same likely product category of “Product Category 1.”

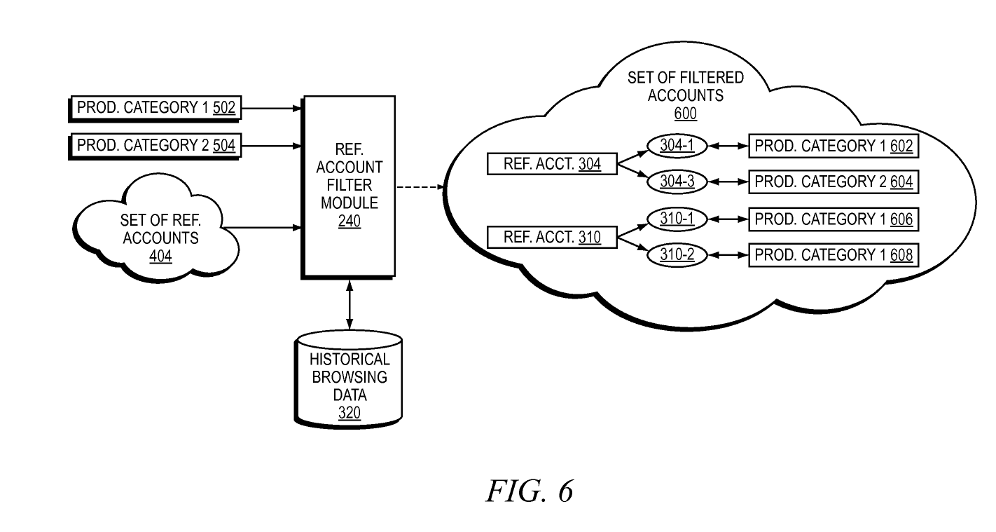

FIG. 6 is a block diagram illustrating a reference account filtering module 240 determining reference accounts that have historical queries in the product categories of the respective, previous queries received from a target account, according to some example embodiments.

Via the reference account filtering module 240, the Translation Engine 134 applies the product categories 502, 504 of the target account's 302 recent historical queries 302-1, 302-2, 302-3 to the set of reference accounts 404 in order to identify a reference account(s) whose matching historical queries 302-2, 304-3, 308-2, 310-1, 310-2 have the same product categories 502, 504. To do so, the Translation Engine 134 accesses the historical browsing data 320 and determines product categories for the matching historical queries 302-2, 304-3, 308-2, 310-1, 310-2 of reference accounts 304, 308, 310. The Translation Engine 134 determines that reference account's 304 historical queries 304-1, 304-3 have similar product categories 602, 604 as the product categories 502, 504 of the target account's 302 recent historical queries 302-1, 302-2, 302-3. The Translation Engine 134 determines that reference account's 310 historical queries 310-1, 310-2 have similar product categories 606, 608 as the product categories 502, 504 of the target account's 302 recent historical queries 302-1, 302-2, 302-3. The Translation Engine generates a set of filtered accounts 600 which includes reference accounts 304 and 310. Reference accounts 304 and 310 thereby have been identified as having historical queries that match the target account's recent queries—and are also related to similar product categories.

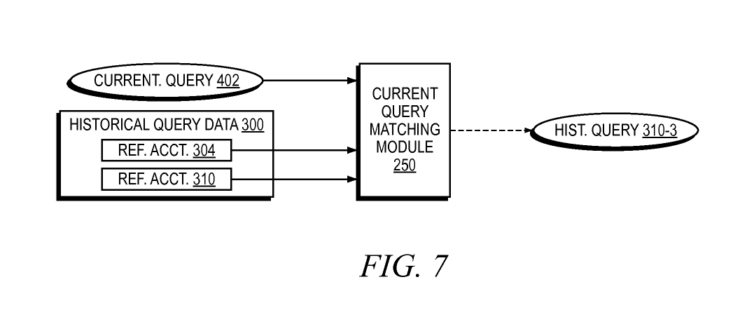

FIG. 7 is a block diagram illustrating a current query matching module 250 determining a filtered account(s) with a historical query that matches a target account's current query, according to some example embodiments.

Via the current query matching module 250, the Translation Engine 134 searches the historical queries of reference accounts 304 and 310—which are in the set of filtered accounts 600—to find a historical query that matches the target account's 302 current query 402. The Translation Engine 302 identifies historical query 310-3 of reference account 310 as a query that is substantially similar to the current query 402.

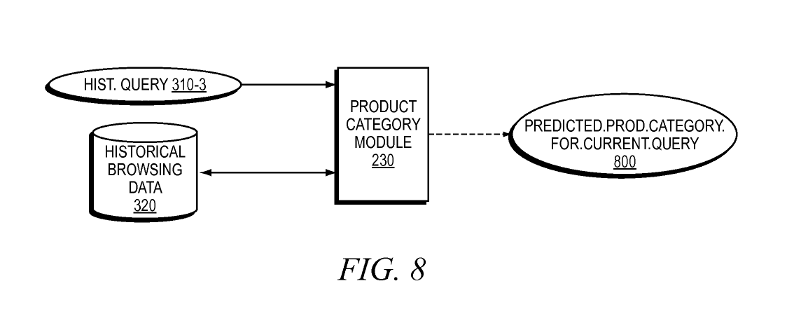

FIG. 8 is a block diagram illustrating a product category module 230 determining a predicted product category of a target account's 302 current query 402, according to some example embodiments. Via the product category module 230, the Translation Engine 134 determines a likely product category of the historical query 310-3 based on reference account's 310 browsing behaviors incidental to the historical query 310-3 in the historical browsing data 320. The Translation Engine 134 assigns the likely product category of the historical query 310-3 as the predicted product category 800 of the current query 402.

The current query 402 is in a first language. Translation Engine 134 generates a plurality of possible translations of the current query in a second language. The Translation Engine 134 generates search results for each possible translation. A select possible translation from the plurality of possible translation that returns the most search results in the predicted product category 800 is identified by the Translation Engine 134 as the most relevant translation of the current query 402.

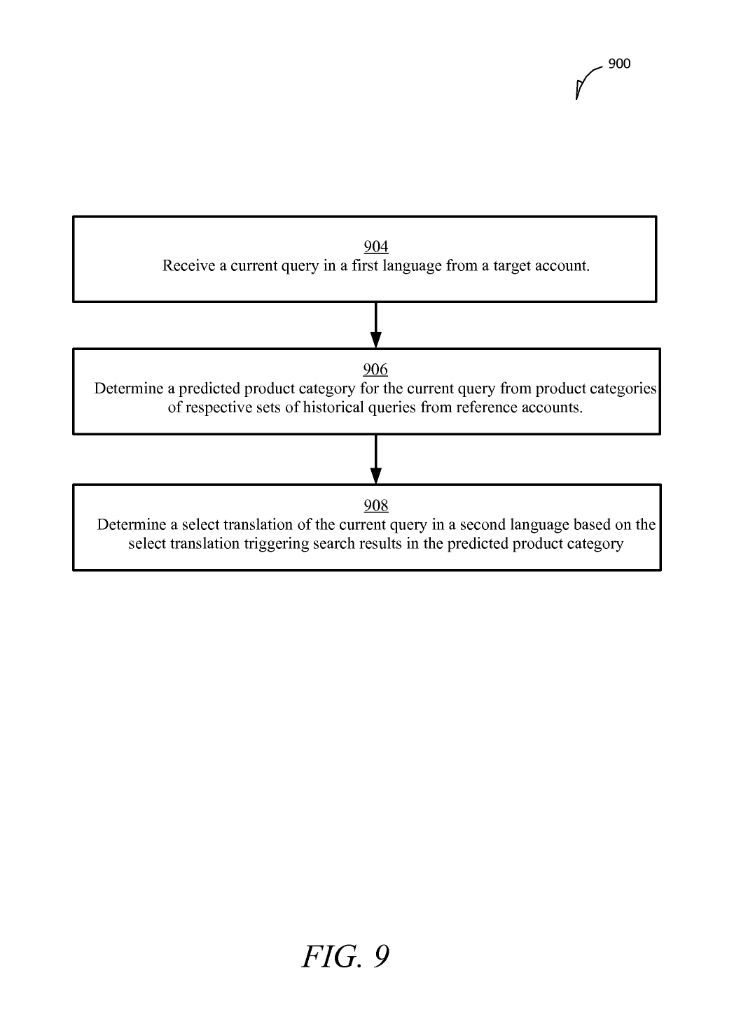

FIG. 9 is a flow diagram illustrating an example of method operations involved in a method 900 of translation a current query of a target account, according to some example embodiments.

At operation 904, the Translation Engine 134 receives a current query in a first language from a target account.

At operation 906, the Translation Engine 134 determines a predicted product category for the current query from product categories of respective sets of historical queries from reference accounts. The Translation Engine 134 identifies a set of the target account's previous queries received prior to the current query. Each of the target account's previous queries has a respective product category (as determined by corresponding historical browsing data). The Translation Engine 134 identifies a plurality of reference accounts based on each reference account having a set of historical queries that meet a threshold of similarity with the set of the target account's previous queries.

The Translation Engine 134 identifies, in the plurality of reference accounts, at least one filtered account with a set of historical queries with respective product categories that meet the threshold of similarity with the respective product categories of the target account's previous queries.

The Translation Engine 134 identifies a respective filtered account having a matching historical query that meets the threshold of similarity with the target account's current query. The Translation Engine 134 identifies a product category of the matching historical query. The Translation Engine 134 assigns the product category of the matching historical query as the predicted product category of the current query.

At operation 908, the Translation Engine 134 determines a select translation of the current query in a second language based on the select translation triggering search results in the predicted product category.

### Exemplary Computer Systems

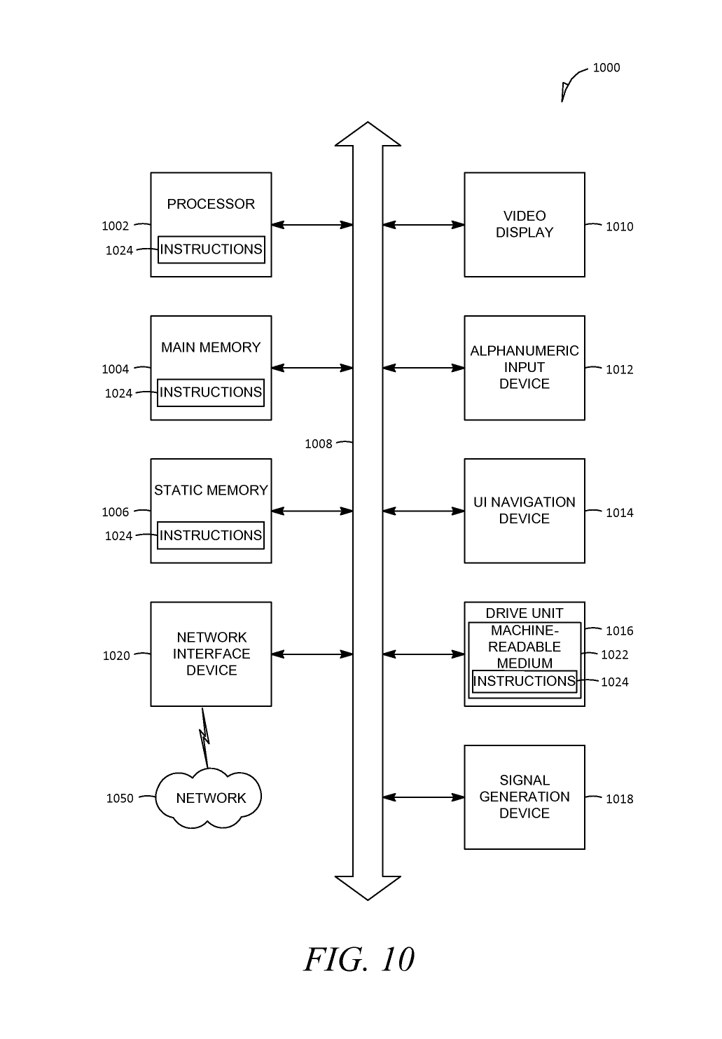

FIG. 10 shows a diagrammatic representation of machine in the example form of a computer system 1000 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 508. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in example embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Furthermore, the following claims are hereby incorporated into the Detailed Description, with each claim standing on its own as a separate embodiment.

What is claimed is:

1. A computer system comprising:
a processor;
a memory device holding an instruction set executable on the processor to cause the computer system to perform operations comprising:
receiving a current query in a first language from a target account;
determining a predicted product category for the current query from product categories of respective sets of historical queries from reference accounts; and
determining a select translation of the current query in a second language based on the select translation triggering search results in the predicted product category.

2. The computer system of claim 1, wherein determining a predicted product category for the current query from product categories of respective sets of historical queries from reference accounts comprises:
identifying a set of the target account's previous queries received prior to the current query, each of the target account's previous queries having a respective product category; and
identifying a plurality of reference accounts based on each reference account having a set of historical queries that meet a threshold of similarity with the set of the target account's previous queries.

3. The computer system of claim 2, comprising:
identifying, in the plurality reference accounts, at least one filtered account with a set of historical queries with respective product categories that meet the threshold of similarity with the respective product categories of the target account's previous queries.

4. The computer system of claim 3, comprising:
identifying a respective filtered account having a matching historical query that meets the threshold of similarity with the target account's current query;
identifying a product category of the matching historical query; and
assigning the product category of the matching historical query as the predicted product category of the current query.

5. The computer system of claim 1, further comprising:
for any respective account's query, determining a product category for the query based at least on a predefined product category that corresponds with browsing activity of at least one search result returned by the respective account's query.

6. The computer system of claim 5, wherein browsing activity comprises at least one of: selection, viewing, purchasing, and rating of the at least one search result returned by the respective account's query.

7. The computer system of claim 1, wherein determining a select translation of the current query in the second language that triggers search results in the predicted product category comprises:
determining a plurality of possible translations for the current query in the second language; and
selecting the select translation from the plurality of possible translations.

8. A computer-implemented method, comprising:
receiving a current query in a first language from a target account;
determining a predicted product category for the current query from product categories of respective sets of historical queries from reference accounts; and
determining a select translation of the current query in a second language based on the select translation triggering search results in the predicted product category.

9. The computer-implemented method of claim 8, wherein determining a predicted product category for the current query from product categories of respective sets of historical queries from reference accounts comprises:
identifying a set of the target account's previous queries received prior to the current query, each of the target account's previous queries having a respective product category; and
identifying a plurality of reference accounts based on each reference account having a set of historical queries that meet a threshold of similarity with the set of the target account's previous queries.

10. The computer-implemented method of claim 9, comprising:
identifying, in the plurality reference accounts, at least one filtered account with a set of historical queries with respective product categories that meet the threshold of similarity with the respective product categories of the target account's previous queries.

11. The computer-implemented method of claim 10, comprising:
identifying a respective filtered account having a matching historical query that meets the threshold of similarity with the target account's current query;
identifying a product category of the matching historical query; and
assigning the product category of the matching historical query as the predicted product category of the current query.

12. The computer-implemented method of claim 8, further comprising:
for any respective account's query, determining a product category for the query based at least on a predefined product category that corresponds with browsing activity of at least one search result returned by the respective account's query.

13. The computer-implemented method of claim 12, wherein browsing activity comprises at least one of: selection, viewing, purchasing, and rating of the at least one search result returned by the respective account's query.

14. The computer-implemented method of claim 8, wherein determining a select translation of the current query in the second language that triggers search results in the predicted product category comprises:
determining a plurality of possible translations for the current query in the second language; and
selecting the select translation from the plurality of possible translations.

15. A non-transitory computer-readable medium storing executable instructions thereon, which, when executed by a processor, cause the processor to perform operations including:
receiving a current query in a first language from a target account;
determining a predicted product category for the current query from product categories of respective sets of historical queries from reference accounts; and
determining a select translation of the current query in a second language based on the select translation triggering search results in the predicted product category.

16. The non-transitory computer-readable medium of claim 15 wherein determining a predicted product category for the current query from product categories of respective sets of historical queries from reference accounts comprises:
identifying a set of the target account's previous queries received prior to the current query, each of the target account's previous queries having a respective product category; and
identifying a plurality of reference accounts based on each reference account having a set of historical queries that meet a threshold of similarity with the set of the target account's previous queries.

17. The non-transitory computer-readable medium of claim 16, comprising:
identifying, in the plurality reference accounts, at least one filtered account with a set of historical queries with respective product categories that meet the threshold of similarity with the respective product categories of the target account's previous queries.

18. The non-transitory computer-readable medium of claim 17, comprising:
identifying a respective filtered account having a matching historical query that meets the threshold of similarity with the target account's current query;
identifying a product category of the matching historical query; and
assigning the product category of the matching historical query as the predicted product category of the current query.

19. The non-transitory computer-readable medium of claim 15, further comprising:
for any respective account's query, determining a product category for the query based at least on a predefined product category that corresponds with browsing activity of at least one search result returned by the respective account's query.

20. The non-transitory computer-readable medium of claim 19, wherein browsing activity comprises at least one of: selection, viewing, purchasing, and rating of the at least one search result returned by the respective account's query.
